(19) United States
(12) Patent Application Publication
(10) Pub. No.: US 2025/0288976 A1
(43) Pub. Date: Sep. 18, 2025

(54) PHOTOCATALYST, CATALYST FILTER INCLUDING THE PHOTOCATALYST, AND FILTERING SYSTEM INCLUDING THE CATALYST FILTER

(71) Applicants: SAMSUNG ELECTRONICS CO., LTD., Suwon-si (KR); POSTECH RESEARCH AND BUSINESS DEVELOPMENT FOUNDATION, Pohang-si (KR)

(72) Inventors: Min Seok KOO, Suwon-si (KR); Jong Kyu KIM, Pohang-si (KR); Jawon KIM, Pohang-si (KR); Jaerim KIM, Pohang-si (KR); Junghyun PARK, Pohang-si (KR); Hyun Chul LEE, Suwon-si (KR); Dongjin HAM, Suwon-si (KR); Inyong HWANG, Pohang-si (KR)

(21) Appl. No.: 19/024,202

(22) Filed: Jan. 16, 2025

(30) Foreign Application Priority Data
Mar. 14, 2024 (KR) 10-2024-0035986
Apr. 2, 2024 (KR) 10-2024-0044790

(51) Int. Cl. B01J 23/50; B01D 53/00; B01D 53/86; B01D 53/88; B01J 21/06; B01J 35/30; B01J 35/39; B01J 35/45

(52) U.S. Cl. CPC B01J 23/50; B01D 53/007; B01D 53/8687; B01D 53/885; B01J 21/063; B01J 35/39; B01J 35/393; B01J 35/45; B01D 2255/104; B01D 2255/2092; B01D 2255/802; B01D 2255/9155; B01D 2255/9202; B01D 2257/708; B01D 2259/802; B01D 2259/804

(57) ABSTRACT

Provided is a catalyst filter including: a filter frame defining a plurality of first recesses therein; and a photocatalyst provided in each of the plurality of first recesses, where the photocatalyst includes a support including a metal compound and metal nanoparticles including aluminum (Al) or silver (Ag), and the metal nanoparticle is embedded in the support.

### CROSS-REFERENCE TO RELATED APPLICATION

This application claims priority to Korean Patent Application No. 10-2024-0035986, filed on Mar. 14, 2024, and Korean Patent Application No. 10-2024-0044790, filed on Apr. 2, 2024, and all the benefits accruing therefrom under 35 U.S.C. § 119, the content of which in their entirety are herein incorporated by reference.

### BACKGROUND

### 1. Field

The disclosure relates to a photocatalyst, a catalyst filter including the photocatalyst, and a filtering system including the catalyst filter.

### 2. Description of the Related Art

In order to remove pollutants from the air, a method of adsorbing/removing gas pollutants by applying an adsorbent (e.g., activated carbon) with a large specific surface area to an air purification filter has been used. In such an adsorption/removing method, adsorbed gas pollutants are detached, causing secondary pollution, and a separate regeneration process such as heating the adsorbent to a high temperature is necessary for reuse of the adsorbent, thereby greatly degrading the performance of adsorbent in moist conditions.

Ceramic catalyst filters (“CCF”) are under development, which may effectively and simultaneously remove fine dust (“PM”) and volatile organic compounds (“VOCs”). However, due to a high aspect ratio of ceramic catalyst filter, there is a limitation in that the inner area of a channel of a ceramic catalyst filter does not receive a sufficient amount of light energy, and thus, photocatalyst efficiency may deteriorate. To overcome this limitation, methods of improving the surface structure of a photocatalyst coating layer have been proposed.

### SUMMARY

Provided are a photocatalyst with improved activation, a catalyst filter including the photocatalyst, and a filtering system including the catalyst filter.

Additional aspects will be set forth in part in the description which follows and, in part, will be apparent from the description, or may be learned by practice of the presented embodiments.

According to an aspect of the disclosure, a photocatalyst includes a support including a metal compound, and metal nanoparticles including aluminum (Al) or silver (Ag), wherein the metal nanoparticles are embedded in the support.

The oxidation number of the metal nanoparticle may be 0.

The metal compound may include titanium dioxide (TiO₂), tungsten trioxide (WO₃), or zinc peroxide (ZnO₂).

The TiO₂ may include anatase TiO₂

The surface refractive index of the support may be 1 to 3.

The surface refractive index of the support may be 1, and a localized surface plasmon resonance (“LSPR”) effect may occur at a wavelength of about 350 nanometers (nm) to about 400 nm.

The surface refractive index of the support may be 2, and a localized surface plasmon resonance (“LSPR”) effect may occur at a wavelength of about 450 nm to about 550 nm.

The diameter of each of the metal nanoparticles may be about 10 nm to about 100 nm.

The photocatalyst may be configured to decompose and remove gaseous volatile organic compounds (VOCs).

According to another aspect of the disclosure, a catalyst filter includes: a filter frame defining a plurality of first recesses therein, and a photocatalyst provided in each of the plurality of first recesses, where the photocatalyst includes a support including a metal compound, and metal nanoparticles including Al or Ag, and the metal nanoparticles are embedded in the support.

The catalyst filter may further include a plurality of second recesses alternately arranged with the plurality of first recesses.

The thickness of the photocatalyst may be about 1 nm to about 10 nm.

The oxidation number of the metal nanoparticle may be 0.

The metal compound may include at least one of TiO₂, WO₃, and ZnO₂.

The TiO₂ may include anatase TiO₂.

According to another aspect of the disclosure, a filtering system includes: a catalyst filter including a filter frame defining a plurality of first recesses therein, and a photocatalyst provided in each of the plurality of first recesses, where the photocatalyst includes a support including a metal compound, metal nanoparticles include Al or Ag, and the metal nanoparticles are embedded in the support; and a light source provided to emit light to activate the photocatalyst.

The light source may be provided in plurality.

The oxidation number of the metal nanoparticle may be 0.

The metal compound may include at least one of TiO₂, WO₃, and ZnO₂.

The TiO₂ may include anatase TiO₂.

### BRIEF DESCRIPTION OF THE DRAWINGS

These and/or other aspects will become apparent and more readily appreciated from the following description of the embodiments, taken in conjunction with the accompanying drawings in which:

FIG. 1 schematically illustrates a filtering system including a catalyst filter, according to an embodiment;

FIG. 2 is a cross-sectional view of the filtering system including the catalyst filter illustrated in FIG. 1;

FIG. 3 is an enlarged cross-sectional view of a region A of FIG. 2;

FIG. 4 is a cross-sectional view of a filter system including a catalyst filter, according to an embodiment;

FIG. 5A includes graphs showing energies of photocatalyst according to a comparative example and an embodiment;

FIGS. 5B and 5C are graphs showing strengths of an electric field of a photocatalyst according to a comparative example and an embodiment;

FIGS. 6A and 6B are graphs showing absorbance of a photocatalyst according to a comparative example and an embodiment;

FIG. 6C is a graph showing the location of a localized surface plasmon resonance (LSPR) peak center of a photocatalyst according to an embodiment;

FIGS. 7A to 7C are views showing light transmission of a catalyst filter according to a comparative example and an embodiment;

FIGS. 8A and 8B are scanning electron microscopy (“SEM”) images of catalyst filters according to a comparative example and an embodiment;

FIG. 8C is an analysis graph of scanning electron microscopy (“SEM”)-energy dispersive X-ray spectroscopy (“EDS”) of a catalyst filter according to an embodiment;

FIG. 9 is a graph showing a diameter change of metal nanoparticles according to an annealing time and a coating thickness;

FIGS. 10A to 10C are graphs showing absorbance of a photocatalyst according to an embodiment;

FIGS. 11A and 11B are graphs showing absorbance of a photocatalyst according to an embodiment; and

FIG. 11C is a graph showing volatile organic compounds (VOCs) removal efficiency of a catalyst filter according to an embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a photocatalyst, a catalyst filter including the photocatalyst, and a filtering system including the catalyst filter according to some embodiments are described in detail with reference to the accompanying drawings. Throughout the drawings, like reference numerals denote like elements, and sizes of components in the drawings may be exaggerated for convenience of explanation and clarity. Furthermore, as embodiments described below are examples, other modifications may be produced from the embodiments.

When a constituent element is disposed “above” or “on” to another constituent element, the constituent element may include not only an element directly contacting and disposed on the other constituent element, but also an element disposed above the other constituent element in a non-contact manner. An expression used in the singular encompasses the expression of the plural, unless it has a clearly different meaning in the context. It will be further understood that the terms “comprises” and/or “comprising” used herein specify the presence of stated features or elements, but do not preclude the presence or addition of one or more other features or elements.

The use of terms “a,” “an,” “the,” and similar referents in the context of describing the disclosure is to be construed to cover both the singular and the plural. The operations of all methods described herein can be performed in any suitable order unless otherwise indicated herein or otherwise clearly contradicted by context.

Furthermore, the connecting lines, or connectors shown in the various figures presented are intended to represent functional relationships and/or physical or logical couplings between the various elements.

The use of any and all examples, or language (e.g., “such as”) provided herein, is intended merely to better illuminate the disclosure and does not pose a limitation on the scope of the disclosure unless otherwise claimed.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10%, 5% or 2% of the stated value.

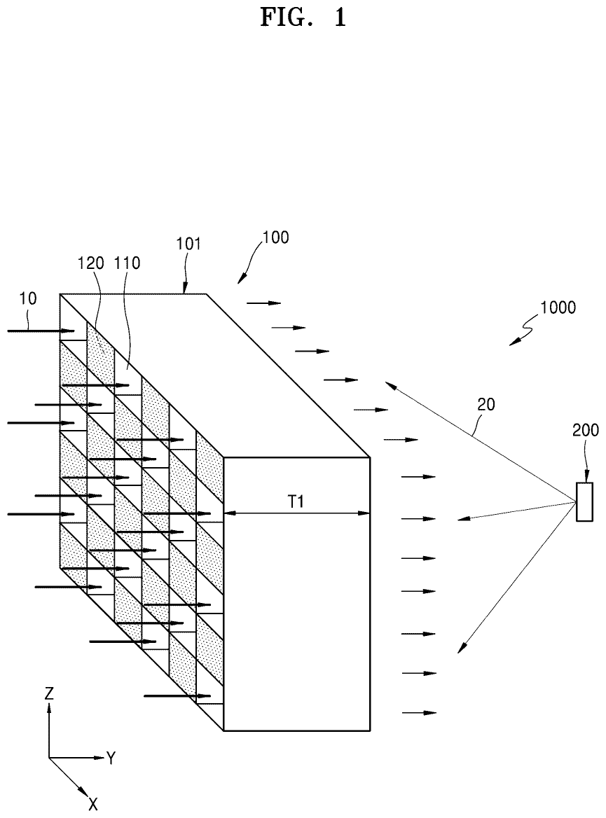

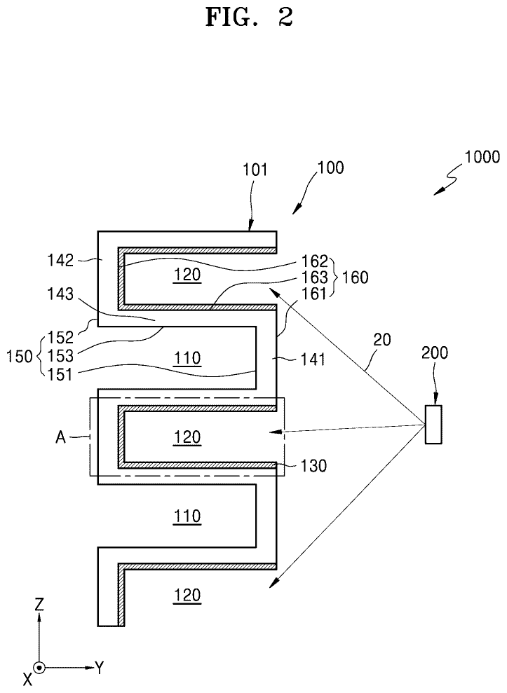

FIG. 1 schematically illustrates a filtering system 1000 including a catalyst filter 100, according to an embodiment. FIG. 2 is a cross-sectional view of the filtering system 1000 including the catalyst filter 100 illustrated in FIG. 1.

Referring to FIGS. 1 and 2, the filtering system 1000 may include a catalyst filter 100 and a light source 200. The catalyst filter 100 may include a filter frame 101 and a photocatalyst 130. The catalyst filter 100 may be, for example, a ceramic catalyst filter.

The filter frame 101 may include an inflow surface (a first surface 150) at a first side where a gas, for example, a material 10, that is subject to purification flows into, and a discharge surface (a second surface 160) at a second side where the gas is discharged. A plurality of channels is formed in the discharge surface, that is, the second surface 160. The material 10 may include at least two types of material to be filtered or removed. The material 10 may include, for example, particulate materials such as fine dust, bio materials such as viruses, germs, and bacteria, and/or gaseous materials such as volatile organic compounds. The filter frame 101 may has a structure to filter particulate materials and/or bio materials. The filter frame 101 may have a porous structure to filter, for example, particulate materials. Particulate materials may be, for example, particles having a diameter of 10 micrometers (μm) or less, that is, particulates of PM10 or less. The particulates may include, for example, fine dust or ultrafine dust having a diameter less than the diameter of the fine dust, but the disclosure is not limited thereto.

The filter frame 101 may have a thickness T1. The first surface 150 and the second surface 160 may face each other in a thickness direction, for example, a Y direction. The thickness direction Y is a direction into which the material 10 flows. The filter frame 101 may have a wall-flow structure. For example, the filter frame 101 may define a plurality of first recesses 110 and a plurality of second recesses 120 therein. The first recesses 110 and the second recesses 120 may be alternately arranged two-dimensionally in directions perpendicular to the thickness direction Y. The second recesses 120 may form channels.

The first recesses 110 may extend in the thickness direction Y and each may be opened at the first side, that is, the first surface 150, and closed at the second side, that is, the second surface 160. The second recesses 120 may have a shape of extending in the thickness direction Y with the second side being opened and the first side being closed. The material 10 may mainly flow into the filter frame 101 through the first recesses 110, and the gas having passed through the filter frame 101 may be mainly discharged through the second recesses 120. The gas discharged through second recesses 120 may be relatively clean or innocuous gas obtained by filtering harmful substances or impurities from the material 10 flowing in through the first recesses 110 or may include the gas and air. Part of the material 10 may flow in through a portion between the first recesses 110, and the gas having passed through the filter frame 101 may be discharged through the second recesses 120. Part of the material 10 may flow in through a bottom portion of the first recesses 110, and the gas having passed through the filter frame 101 may be discharged through a portion between the second recesses 120.

The first recesses 110 and the second recesses 120 may be arranged regularly or irregularly. For example, the first recesses 110 and the second recesses 120 may be alternately arranged two-dimensionally in the directions perpendicular to the thickness direction Y, for example, an X direction and a Z direction.

The filter frame 101 may have a shape to define the first recesses 110 and the second recesses 120. The filter frame 101 may include, for example, a first part 141 blocking the second side of the first recesses 110, a second part 142 blocking the first side of the second recesses 120, and a third part 143 forming a boundary between the first recesses 110 and the second recesses 120. The first part 141 and the second part 142 are apart from each other in the thickness direction Y, and a plurality of first parts 141 and a plurality of second parts 142 may be arranged in the Z direction. The third part 143 may extend from the edge of the first part 141 In the Y direction to be connected to the second part 142. The third parts 143 may connect the first part 141 and the second part 142 to each other zigzag in the Z direction and X direction.

The thicknesses of the first part 141 and the second part 142 may be the same as or different from the thickness of the third part 143. The first side surfaces 151, 152, and 153 of the first part 141, the second part 142, and the third part 143 may constitute the first surface 150, and second side surfaces 161, 162, and 163 of the first part 141, the second part 142, and the third part 143 may constitute the second surface 160. Accordingly, the filter frame 101 having a wall-flow structure in which the areas of the first surface 150 and the second surface 160 expand may be implemented.

The filter frame 101 may have a monolithic structure in which the first part 141, the second part 142, and the third part 143 are connected as one body. To form such a monolithic structure, the first part 141 and the second part 142 may be formed integrally with the third part 143. In another example, the filter frame 101 may have a structure in which the first part 141 and the second part 142 are inserted in a zigzag shape with respect to an arrangement of the third part 143 having a length corresponding to the thickness T1. In another example, the filter frame 101 may have a structure in which the first part 141 and the second part 142 arranged in a zigzag shape are connected to the third part 143.

In FIG. 2, the first part 141 and the second part 142 are illustrated as integrally forming a monolithic structure with the third part 143, the disclosure is not limited thereto, and various modifications are possible.

The sizes of the first recesses 110 and the second recesses 120 may be the same. For example, the width in the X direction and the width in the Z direction of each of the first recesses 110 may the same as or different from the width in the X direction and the width in the Z direction of each of the second recesses 120, respectively. The length in the thickness direction Y of each of the first recesses 110 may be the same as or different from the same as the length in the thickness direction Y of each of the second recesses 120. The sizes of the first recesses 110 may be the same or different from each other. The sizes of the second recesses 120 may be the same or different from each other.

The filter frame 101 may include a porous material, for example, a porous ceramic material, that filters particulate materials. A ceramic material may include, for example, cordierite, SiC, Al₂TiO₅, and the like. Permeability of each of the first part 141 and the second part 142 may be lower than the permeability of the third part 143. In this case, the material 10 may flow into the filter frame 101 through the first recesses 110, and the gas may mainly pass through the third part 143 and may be discharged through the second recesses 120. The first part 141 and the second part 142 may each be non-permeable. Furthermore, the permeability of each of the first part 141 and the second part 142 may be the same as the permeability of the third part 143. In this case, as the area of the third part 143 is greater than the area of each of the first part 141 and the second part 142, the material 10 may flow into the filter frame 101 mainly through the first recesses 110, and the gas may mainly pass through the third part 143 to be discharged through the second recesses 120.

As such, the material 10 may flow into the filter frame 101 mainly through the first recesses 110, and particulate materials, bio materials, and the like of the material 10 may be filtered by the third part 143, and the gas having passed through the third part 143 may be discharged through the second recesses 120.

The photocatalyst 130 may be used for decomposition and removal of gaseous volatile organic compounds (VOCs). A gas ingredient included in the material 10 may pass through the filter frame 101 to be in contact with the photocatalyst 130. The gas ingredient may be decomposed causing a photocatalyst oxidation reaction while passing through the photocatalyst 130. The gas ingredient may be volatile organic compounds (VOCs) or other harmful gases. The volatile organic compound may include, for example, formaldehyde, acetaldehyde, ammonia, toluene, acetic acid, or the like. The bio particles having passed through filter frame 101 may be additionally removed by the photocatalyst 130 in a photocatalyst operation.

The light source 200 may emit light, for example, an ultraviolet ray or light of from an ultraviolet band to a visible light band, to activate the photocatalyst 130 in the second surface 160 of the catalyst filter 100.

An optical waveguide (not shown) may be provided in each of a plurality of channels formed on the second surface 160 of the filter frame 101 to efficiently transmit light to the inside of each of the channels of the catalyst filter 100. A plurality of optical waveguides (not shown) may be inserted in a plurality of channels formed on the second surface 160 of the filter frame 101 to efficiently transmit light to the inside of each of the channels of the catalyst filter 100. In other words, a plurality of optical waveguides (not shown) may be inserted in the second recesses 120 of the filter frame 101. Light 20 generated from the light source 200 may be transmitted to a deep position inside the second recesses 120 through the optical waveguide (not shown).

The light source 200 may include only one light source. In another example, the light source 200 may include a plurality of light sources. The light source included in the light source 200 may be a light-emitting diode (“LED”), but the disclosure is not limited to the LED, and any light source capable of discharging light energy to activate the photocatalyst 130 in the second recesses 120 may be used as the light source 200.

A radiation angle of the light 20 discharged from the light source 200 may be limited considering, for example, the size (e.g., a width and a depth) of the second recesses 120, and the like. The radiation angle of the light source 200 may be limited such that the light 20 partially arrives at the bottom of each of the second recesses 120.

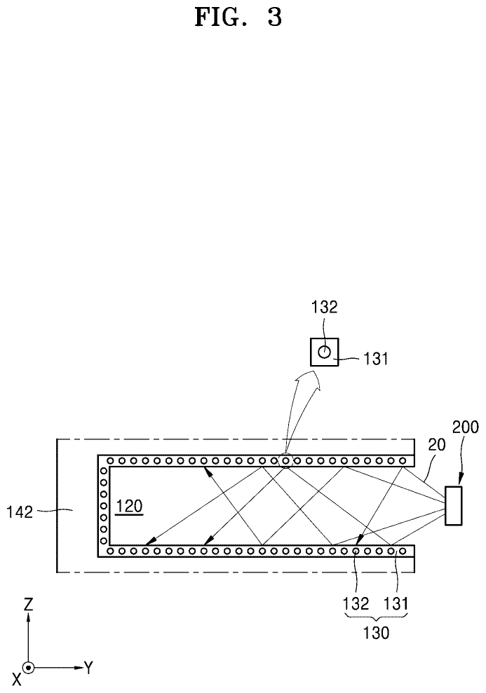

FIG. 3 is an enlarged cross-sectional view of a region A of FIG. 2.

Referring to FIGS. 2 and 3, the photocatalyst 130 may be provided in at least part of the second surface 160 of the filter frame 101. The photocatalyst 130 may be provided to remove a harmful gas through a photocatalyst operation from the gaseous material having passed through the filter frame 101.

The photocatalyst 130 may be formed in at least part of the second surface 160 of the filter frame 101 by coating, a chemical vapor deposition method, a physical vapor deposition method, and the like. As the material 10 described above flows into the filter frame 101 mainly through the first recesses 110, the particulate materials, bio materials, and the like of the material 10 are filtered by the third part 143, and the gas having passed through the third part 143 is discharged through the second recesses 120, the photocatalyst 130 may be formed the second side surface 163 of at least the third part 143 of the second surface 160. As the gas may flow into the second recesses 120 by passing through the second part 142, the photocatalyst 130 may also be formed in the second side surface 162 of the second part 142 forming a first sidewall of the second recesses 120 with the second side surface 163 of the third part 143. In other words, the photocatalyst 130 may be further formed in the second side surface 162 of the second part 142. Furthermore, the photocatalyst 130 may be further formed in the second side surface 161 of the first part 141. As such, the photocatalyst 130 may be formed in at least some of the second side surfaces 161, 162, and 163 of the first part 141, the second part 142, and the third part 143. FIG. 2 illustrates an example in which the photocatalyst 130 is formed in the second side surfaces 162 and 163 of the second part 142 and the third part 143.

The photocatalyst 130 may include a support 131 and a metal nanoparticle 132. The support 131 may include a metal compound that causes a photocatalyst reaction by receiving light energy. The metal compound may include a material having semiconductor properties, for example, titanium dioxide (TiO₂), tungsten trioxide (WO₃) or zinc peroxide (ZnO₂), and the like. The metal compound may include, for example, anatase TiO₂. Accordingly, various chemical reactions (e.g., various oxidation reactions, etc.) for pollution material removing may effectively take place. The light energy may be ultraviolet energy or visible light energy.

A surface refractive index n of support 131 may be, for example, 1 to 3. The surface refractive index n of the support 131 may be, for example, 1 to 5. As the surface refractive index n of the support 131 increases, a localized surface plasmon resonance (LSPR) peak moves toward a long wavelength side, and thus, the efficiency of the photocatalyst 130 may be improved.

The metal nanoparticle 132 may include aluminum (Al) or silver (Ag). The metal nanoparticle 132 may be embedded in the support 131. In an embodiment, the metal nanoparticle 132 may be completely surrounded by the support 131 (This is referred to as “fully-embedded”). In another embodiment, the metal nanoparticle 132 may be partially surrounded by the support 131 (This is referred to as “partially-embedded”). As the metal nanoparticle 132 is embedded in the support 131, due to the interaction between the metal nanoparticle 132 and the support 131, an LSPR effect may occur. As the metal nanoparticle 132 is fully embedded in the support 131, the LSPR peak is moved to the long wavelength side and thus, the efficiency of the photocatalyst 130 may be improved.

Due to the LSPR effect, the light 20 discharged from the light source 200 may arrive at the deep inside of the second recesses 120, that is, the inside of the channel. In other words, the light 20 discharged from the light source 200 may be irradiated in a large range inside the second recesses 120 corresponding thereto. In other words, as the light energy is irradiated to the photocatalyst 130 across the side surface and the bottom of the second recesses 120, causing a photocatalyst reaction in a large range, the efficiency of the photocatalyst 130 may be improved accordingly.

The oxidation number of the metal nanoparticle 132 may be 0. In other words, the metal nanoparticle 132 may exist in the form of a metal, not an oxide.

The diameter of each of the metal nanoparticle 132 may be, for example, about 10 nanometers (nm) to about 100 nm. The diameter of each of the metal nanoparticle 132 may be, for example, about 5 nm to about 200 nm. As the diameter of each of the metal nanoparticle 132 increases, the LSPR peak is moved to the long wavelength side, and thus, the efficiency of the photocatalyst 130 may be improved.

The thickness of the photocatalyst 130 may be, for example, about 1 nm to about 10 nm. The thickness of the photocatalyst 130 may be, for example, about 1 nm to about 20 nm. As the thickness of the photocatalyst 130 increases, the diameter of the metal nanoparticle 132 increases. As the diameter of the metal nanoparticle 132 increases, the location of the center of the LSPR peak moves toward the long wavelength side, and absorbance may be increased.

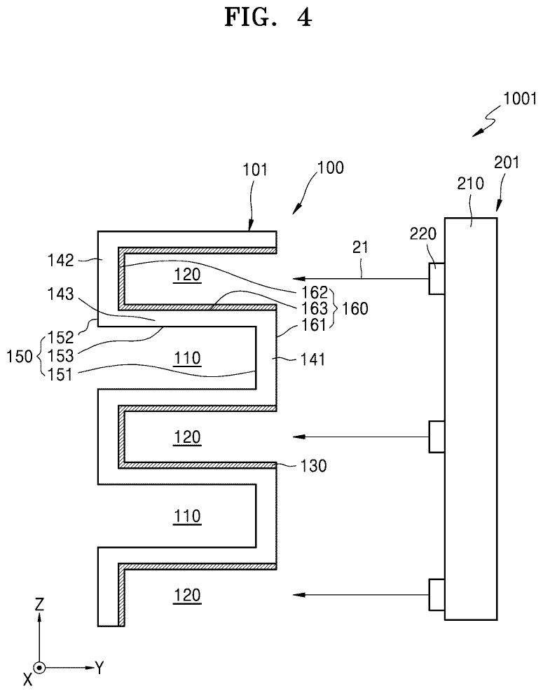

FIG. 4 is a cross-sectional view of a filter system 1001 including a catalyst filter, according to an embodiment. The filter system 1001 of FIG. 4 may be the same as the filtering system 1000 of FIGS. 1 and 2, except that a light source 201 includes a plurality of first light sources 220. In the description of FIG. 4, redundant descriptions to those of FIGS. 1 to 3 are omitted.

Referring to FIG. 4, the light source 201 may include a substrate 210 and the first light sources 220 forming an array on the substrate 210. The first light sources 220 may each be provided to emit an ultraviolet ray or light of from an ultraviolet band to a visible light band. The first light sources 220 may be arranged, for example, to one-to-one correspond to a plurality of channels formed in the second surface 160 of the filter frame 101. The channels may correspond to the second recesses 120 of the filter frame 101. Thus, the first light sources 220 may be arranged to one-to-one correspond to the second recesses 120 of the filter frame 101.

The first light sources 220 may one-to-one correspond to the second recesses 120 that are channels, or may correspond to some of the second recesses 120. The first light sources 220 may be arranged to form an array on one surface of the substrate 210. For example, the interval between the centers of the first light sources 220 neighboring each other may be the same as the interval between the centers of the second recesses 120. The number of the first light sources 220 may be the same as or different from the number of the second recesses 120 of the catalyst filter 100. For example, the number of the first light sources 220 may be the same as the number of the second recesses 120, that is, the number of channels, at the air discharge side of the catalyst filter 100. Accordingly, the first light sources 220 may one-to-one correspond to the channels formed in the second surface 160 of the catalyst filter 100.

The first light sources 220 may include only one light source. In another example, the first light sources 220 may include a plurality of light sources. The light source included in the first light sources 220 may be a LED, but the disclosure is not limited to the LED, and anything capable of discharging light energy to activate the photocatalyst 130 in the second recesses 120 may be used as the first light sources 220.

A radiation angle of light 21 discharged from the first light sources 220 may be limited considering, for example, the size (e.g., a width and a depth) and the like of the second recesses 120. The radiation angle of the first light sources 220 may be limited such that part of the light 21 arrives at the bottom of the second recesses 120.

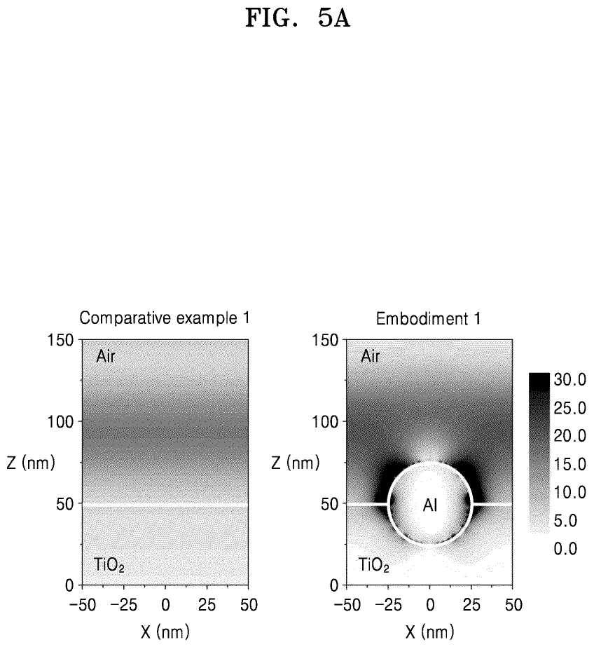

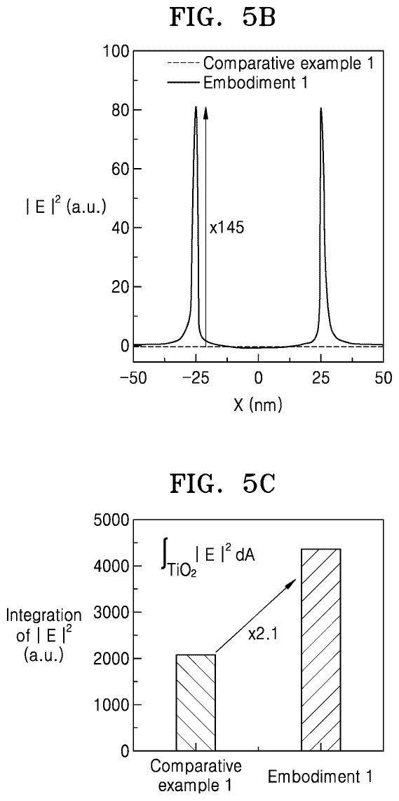

FIG. 5A includes graphs showing energies of photocatalyst according to Comparative Example 1 and Embodiment 1.

Comparative Example 1 uses a titanium dioxide (TiO₂) photocatalyst, and Embodiment 1 uses a TiO₂ photocatalyst in which aluminum (Al) nanoparticles (“NPs”) are embedded.

Referring to FIG. 5A, Comparative Example 1 shows no energy change, whereas it may be seen in Embodiment 1 that energy is generated when Al NPs are embedded in TiO₂. Accordingly, it may be seen that the LSPR effect occurs when Al NPs are embedded in TiO₂.

FIGS. 5B and 5C are graphs showing strengths (|E|²) of an electric field (E) of a photocatalyst according to Comparative Example 1 and Embodiment 1.

Referring to FIGS. 5B and 5C, Embodiment 1 shows the strength of an electric field that is about 145 times and an integral value of the strength of an electric field that is about 2.1 times greater than an integral value of the strength of an electric field of Comparative Example 1. Accordingly, it may be seen that, when Al NPs are embedded in TiO₂, the LSPR effect may occur.

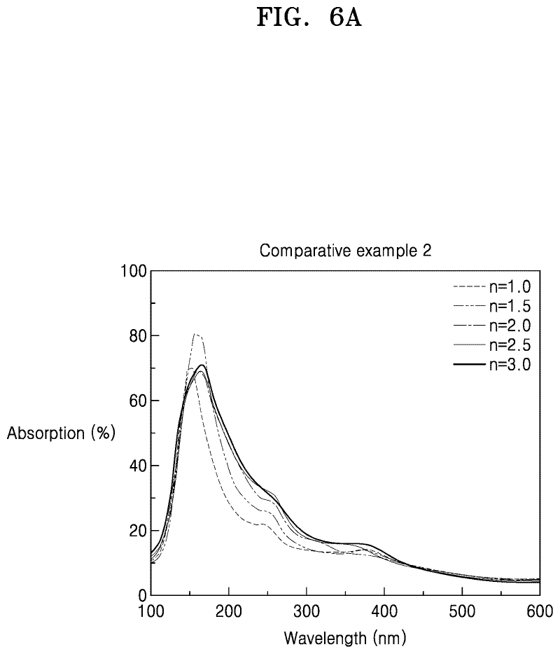

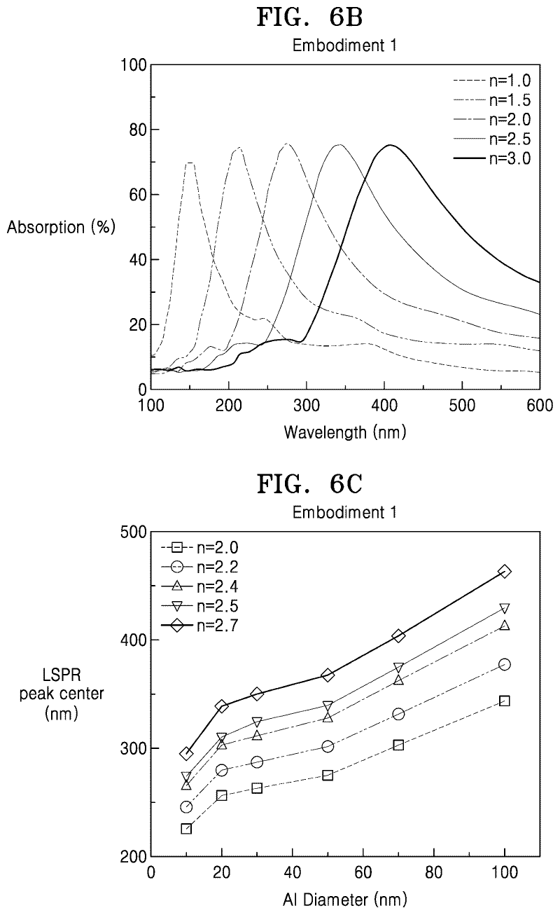

FIGS. 6A and 6B are graphs showing the absorbance of a photocatalyst according to Comparative Example 2 and Embodiment 1.

Comparative example 2 uses a TiO₂ photocatalyst simply coated with Al NPs.

Referring to FIGS. 6A and 6B, it may be seen that, in Comparative Example 2, even when the surface refractive index n is changed, the location of the center of the LSPR peak and absorbance hardly change, whereas in Embodiment 1, as the surface refractive index n increases from 1 to 3, the location of the center of the LSPR peak moves toward the long wavelength side, and absorbance increases.

FIG. 6C is a graph showing the location of the LSPR peak center of a photocatalyst according to Embodiment 1.

Referring to FIG. 6C, it may be seen that, in Embodiment 1, as the surface refractive index n is increased from 2.0 to 2.7, and the diameter of each of Al NPs is increased, the location of the center of the LSPR peak moves toward the long wavelength side.

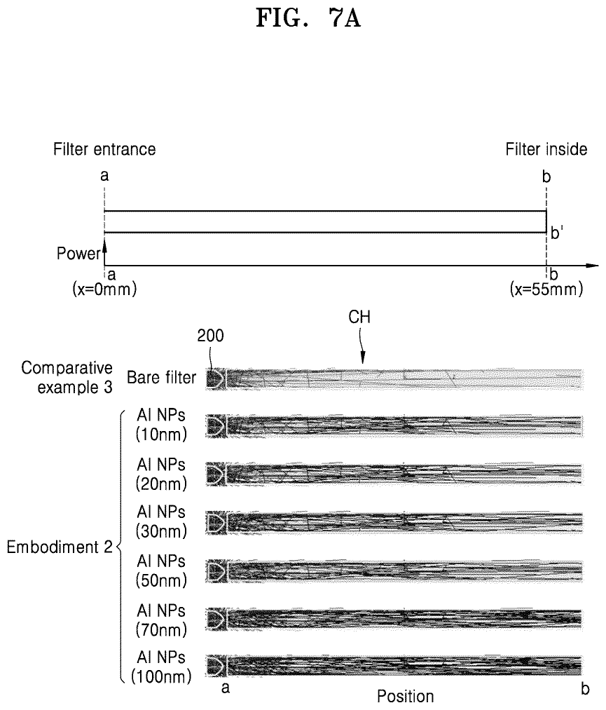

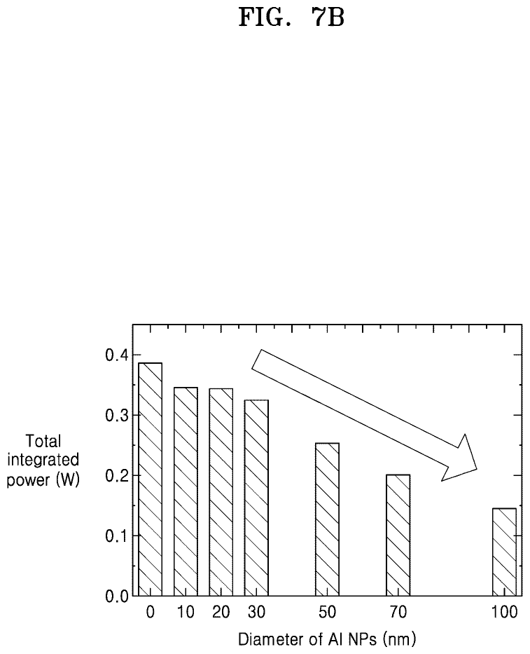

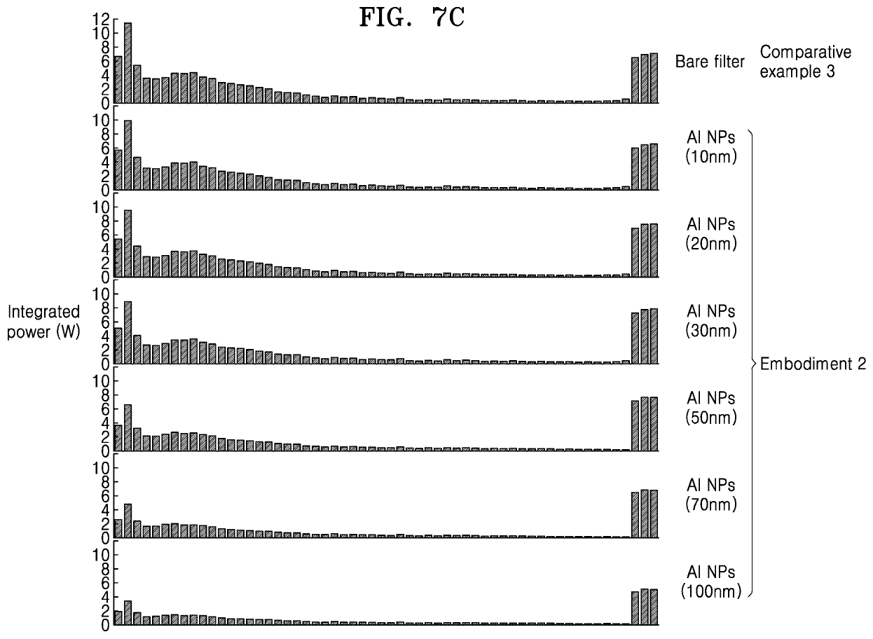

FIGS. 7A to 7C are views showing a light transmission of a catalyst filter according to Comparative Example 3 and Embodiment 2.

Comparative Example 3 uses a catalyst filter including the TiO₂ photocatalyst, and Embodiment 2 uses a catalyst filter including the TiO₂ photocatalyst in which Al NPs are embedded.

Referring to FIG. 7A, in Comparative Example 3, the light emitted from the light source 200 is mainly irradiated to only an entrance side of a filter, and is difficult to arrive at a deep position in a channel CH. In this case, a light reach standard deviation shows a value of 0.002, and a light reach uniformity Z_{cm} shows a value of 0.012951.

In contrast, in Embodiment 2, it may be seen that the light emitted from the light source 200 arrives at a deeper position in the channel CH than Comparative Example 3. Furthermore, it may be seen that, by increasing the diameter of each of Al NPs from about 10 nm to about 100 nm, more amount of the light emitted from the light source 200 efficiently arrives at a deep position (b) in the channel CH. When the diameter of each of Al NPs is about 100 nm, the light reach standard deviation shows a value of 0.0006, and the light reach uniformity Z_{cm} shows a value of 0.015275.

Accordingly, it may be seen that the light reach uniformity improves about 20%, and the light reach standard deviation is reduced.

Referring to FIGS. 7B and 7C, in the case of a catalyst filter including the TiO₂ photocatalyst in which Al NPs are embedded, it may be seen that, due to the Al NPs, absorbance increases and transmittance decreases so that total integrated light power is reduced, but absorbed light power increases due to the LSPR effect of TiO₂ and Al NPs.

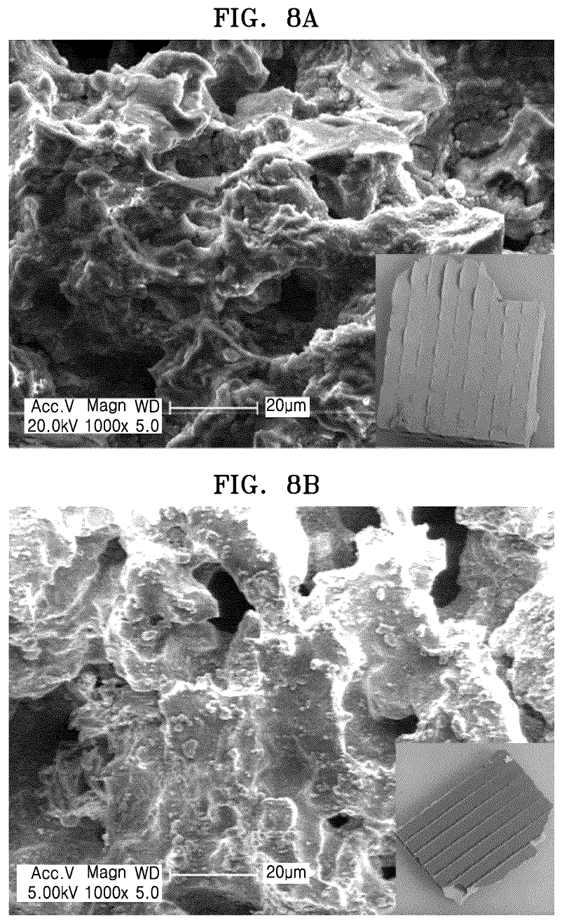

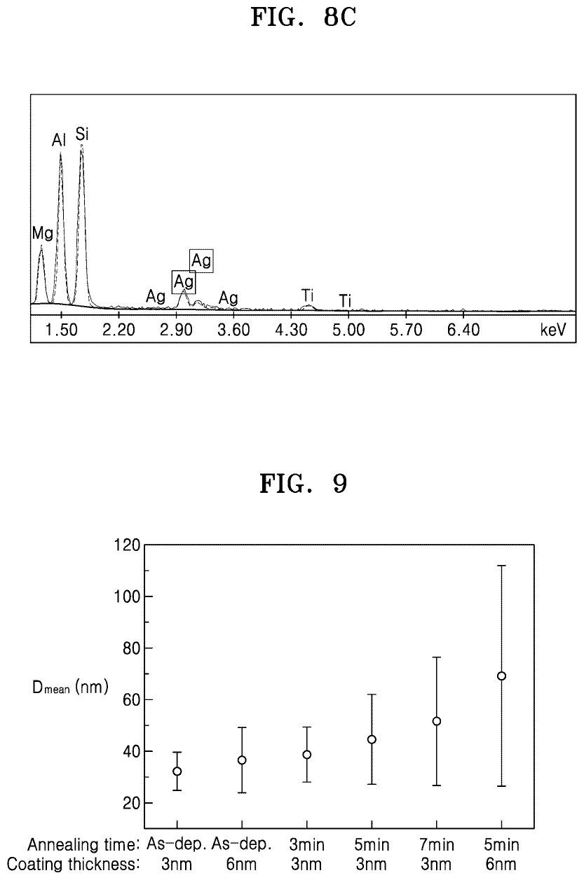

FIGS. 8A and 8B are transmission electron microscopy (“TEM”) images of catalyst filters according to a comparative example and an embodiment, respectively. FIG. 8C is an analysis graph of scanning electron microscope (“SEM”)-energy dispersive X-ray spectroscopy (“EDS”) of a catalyst filter according to an embodiment.

Comparative Example 3 uses a catalyst filter including the TiO₂ photocatalyst, and Embodiment 3 uses a catalyst filter including the TiO₂ photocatalyst in which Al NPs are embedded.

Referring to FIGS. 8A and 8B, it may be seen that, in Embodiment 3, silver (Ag) Nps are well distributed, and when an actual picture at the lower right side is compared with Comparative Example 3, color becomes darker due to Ag in Embodiment 3 of FIG. 8B.

Referring to FIG. 8C, it may be seen through the Ag peak of a SEM-EDS analysis graph that Ag is coated on a catalyst filter surface.

FIG. 9 is a graph showing a diameter change of metal nanoparticles according to an annealing time and a coating thickness. Annealing was performed at about 400 degrees at Celsius (° C.).

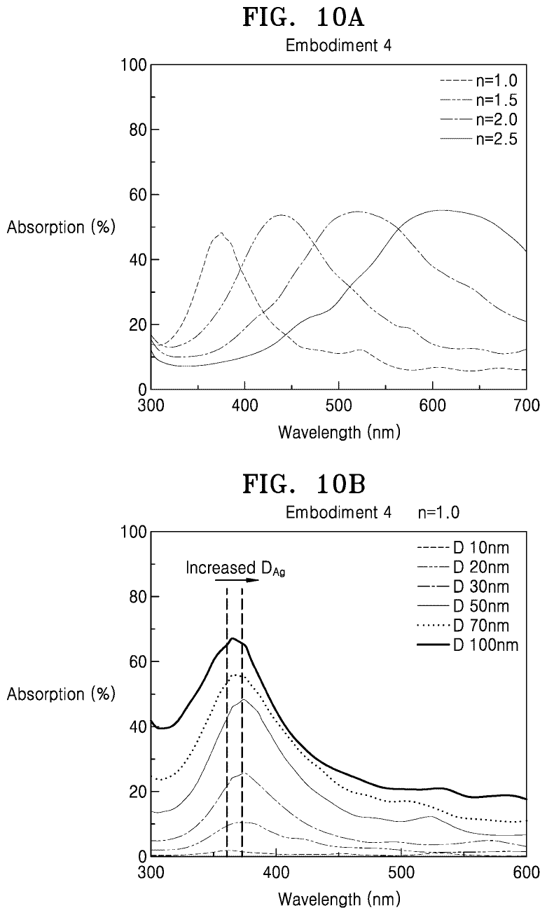

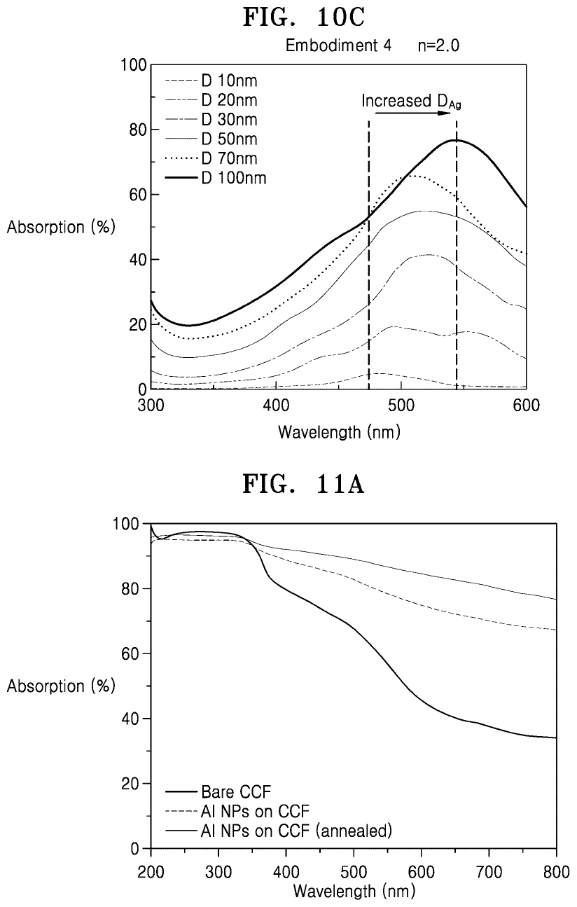

Referring to FIG. 9, in the case of a catalyst filter including the TiO₂ photocatalyst in which Al NPs are embedded, it may be seen that, as an annealing time increases, the diameter of each of Ag NPs increases, and as a coating thickness of the photocatalyst increases, the diameter of each of Ag NPs increases. It may be seen through FIG. 10C to be described below that, as the diameter (D_{Ag}) of each of Ag NPs increases, the location of the center of the LSPR peak moves toward the long wavelength side, and absorbance increases.

FIGS. 10A to 10C are graphs showing absorbance of a photocatalyst according to an embodiment.

Embodiment 4 uses the TiO₂ photocatalyst in which Al NPs are embedded.

Referring to FIG. 10A, in Embodiment 4, it may be seen that, as the surface refractive index n of TiO₂ increases from 1 to 2.5, the location of the center of the LSPR peak moves toward the long wavelength side, and absorbance increases.

FIG. 10B is a graph showing the absorbance of a photocatalyst according to a change in diameter of each of Ag NPs when the surface refractive index n of a TiO₂ support is 1.

Referring to FIG. 10B, it may be seen that, as the diameter of each of Al NPs is increased from about 10 nm to about 100 nm, the location of the center of the LSPR peak moves toward the short wavelength side, and absorbance increases. It may be seen that, when the surface refractive index n is 1, the photocatalyst has the LSPR effect at a wavelength of about 350 nm to about 400 nm.

FIG. 10C is a graph showing the absorbance of a photocatalyst according to a change in diameter of each of Ag NPs when the surface refractive index n of the TiO₂ support is 2.

Referring to FIG. 10C, it may be seen that, as the diameter of each of Al NPs is increased from about 10 nm to about 100 nm, the location of the center of the LSPR peak moves toward the long wavelength side, and absorbance increases. It may be seen that, when the surface refractive index n is 2, the photocatalyst has the LSPR effect at a wavelength of about 450 nm to about 550 nm.

Comparing FIG. 10B with FIG. 10C, it may be seen that, as the surface refractive index n of a TiO₂ support increases, the location of the center of the LSPR peak moves toward the long wavelength side, and absorbance increases.

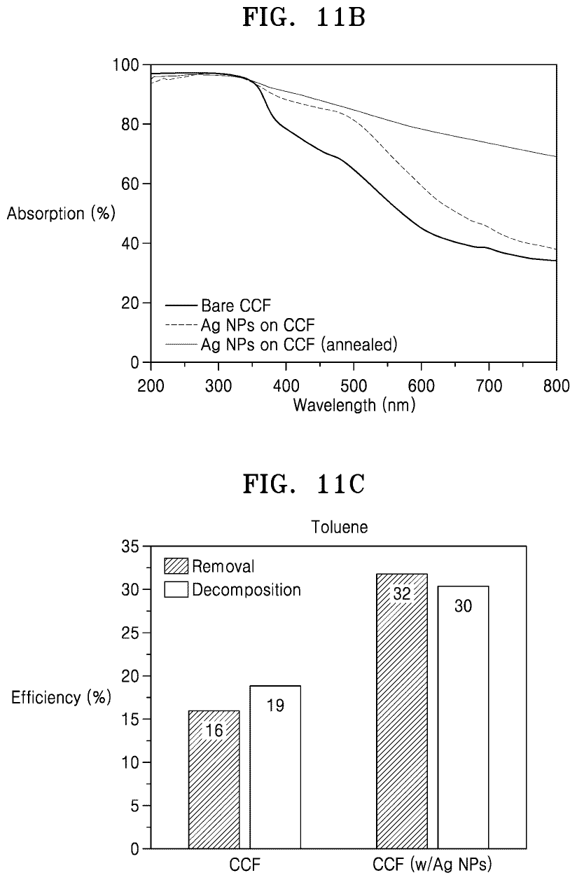

FIGS. 11A and 11B are graphs showing the absorbance of a photocatalyst according to an embodiment.

Referring to FIG. 11A, compared with a catalyst filter (e.g., ceramic catalyst filter CCF) including the TiO₂ photocatalyst, it may be seen that absorbance is improved in a ceramic catalyst filter including the TiO₂ photocatalyst in which Al NPs are embedded, and absorbance is improved when the TiO₂ photocatalyst in which Al NPs are embedded is annealed.

Referring to FIG. 11B, compared with a catalyst filter (e.g., ceramic catalyst filter CCF) including the TiO₂ photocatalyst, it may be seen that absorbance is improved when a catalyst filter (e.g., ceramic catalyst filter CCF) including the TiO₂ photocatalyst in which Ag NPs are embedded, and absorbance is improved when the TiO₂ photocatalyst in which Ag NPs are embedded is annealed.

FIG. 11C is a graph showing volatile organic compounds (VOCs) removal efficiency of a catalyst filter according to an embodiment.

Shown is a result of an experiment of removing and decomposing toluene using a catalyst filter (e.g., ceramic catalyst filter CCF) including the TiO₂ photocatalyst and a catalyst filter (e.g., ceramic catalyst filter CCF) including the TiO₂ photocatalyst in which Ag NPs are embedded. The removal means a ratio of an outlet toluene concentration to an inlet toluene concentration, and the decomposition means a ratio of an outlet CO₂ concentration to an inlet toluene concentration.

Referring to FIG. 11C, the catalyst filter (e.g., ceramic catalyst filter CCF) including the TiO₂ photocatalyst shows removing of 16% and decomposition of 19%, and the catalyst filter including the TiO₂ photocatalyst in which Ag NPs are embedded shows removing of 32% and decomposition of 30%. Accordingly, it may be seen that the volatile organic compounds (VOCs) removal efficiency of a catalyst filter including the TiO₂ photocatalyst in which Ag NPs are embedded is effectively improved.

According to the photocatalyst of the disclosure, it may be seen that, as metal nanoparticles including Al or Ag are embedded in a TiO₂ support, activation of a photocatalyst may be improved, and the volatile organic compounds (VOCs) removal efficiency of a catalyst filter including the photocatalyst and a system including the catalyst filter may be effectively improved.

It should be understood that a photocatalyst, a catalyst filter including the photocatalyst, and a filtering system including the catalyst filter described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A photocatalyst comprising:
a support comprising a metal compound; and
metal nanoparticles comprising aluminum (Al) or silver (Ag),
wherein the metal nanoparticles are embedded in the support.

2. The photocatalyst of claim 1, wherein an oxidation number of the metal nanoparticle is 0.

3. The photocatalyst of claim 1, wherein the metal compound comprises titanium dioxide (TiO₂), tungsten trioxide (WO₃), or zinc peroxide (ZnO₂).

4. The photocatalyst of claim 3, wherein the TiO₂ comprises anatase TiO₂.

5. The photocatalyst of claim 1, wherein a surface refractive index of the support is 1 to 3.

6. The photocatalyst of claim 1, wherein a surface refractive index of the support is 1, and a localized surface plasmon resonance (LSPR) effect occurs at a wavelength of about 350 nanometers (nm) to about 400 nm.

7. The photocatalyst of claim 1, wherein, a surface refractive index of the support is 2, and a localized surface plasmon resonance (LSPR) effect occurs at a wavelength of about 450 nm to about 550 nm.

8. The photocatalyst of claim 1, wherein a diameter of each of the metal nanoparticles is about 10 nm to about 100 nm.

9. The photocatalyst of claim 1, wherein the photocatalyst is configured to decompose and remove gaseous volatile organic compounds (VOCs).

10. A catalyst filter comprising:
a filter frame defining a plurality of first recesses therein; and
a photocatalyst provided in each of the plurality of first recesses,
wherein the photocatalyst comprises a support comprising a metal compound, and metal nanoparticles comprising Al or Ag, and
the metal nanoparticles are embedded in the support.

11. The catalyst filter of claim 10, further comprising a plurality of second recesses alternately arranged with the plurality of first recesses.

12. The catalyst filter of claim 10, wherein a thickness of the photocatalyst is about 1 nm to about 10 nm.

13. The catalyst filter of claim 10, wherein an oxidation number of the metal nanoparticle is 0.

14. The catalyst filter of claim 10, wherein the metal compound comprises at least one of TiO₂, WO₃, and ZnO₂.

15. The catalyst filter of claim 14, wherein the TiO₂ comprises anatase TiO₂.

16. A filtering system comprising:
a catalyst filter comprising a filter frame defining a plurality of first recesses therein, and a photocatalyst provided in each of the plurality of first recesses, wherein the photocatalyst comprises a support comprising a metal compound, metal nanoparticles comprising Al or Ag, and the metal nanoparticles are embedded in the support; and
a light source configured to emit light to activate the photocatalyst.

17. The filtering system of claim 16, wherein the light source is provided in plurality.

18. The filtering system of claim 16, wherein an oxidation number of the metal nanoparticle is 0.

19. The filtering system of claim 16, wherein the metal compound comprises at least one of TiO₂, WO₃, and ZnO₂.

20. The filtering system of claim 19, wherein the TiO₂ comprises anatase TiO₂.
